(19) United States
(12) Patent Application Publication
(10) Pub. No.: US 2017/0222213 A1
(43) Pub. Date: Aug. 3, 2017

(54) METHOD FOR PRODUCING NEGATIVE ELECTRODE FOR LITHIUM ION BATTERY AND METHOD FOR PRODUCING LITHIUM ION BATTERY

(71) Applicant: NEC ENERGY DEVICES, LTD., Sagamihara-shi, Kanagawa (JP)

(72) Inventors: Tomohiko HAYASHI, Kanagawa (JP); Kimiyoshi FUKATSU, Kanagawa (JP)

(73) Assignee: NEC Energy Devices, Ltd., Sagamihara-shi, Kanagawa (JP)

(21) Appl. No.: 15/500,959

(22) PCT Filed: Jul. 28, 2015
(86) PCT No.: PCT/JP2015/071351

§ 371 Date: Feb. 1, 2017

(30) Foreign Application Priority Data
Aug. 5, 2014 (JP) 2014-159627

(51) Int. Cl. H01M 4/1393; H01M 4/04; H01M 4/587; H01M 10/0525; H01M 4/133

(52) U.S. Cl. CPC H01M 4/1393; H01M 10/0525; H01M 4/133; H01M 4/587; H01M 4/0471; H01M 2004/027

(57) ABSTRACT

A method for producing a negative electrode for a lithium ion battery comprising heat-treating a negative electrode active material layer that is placed on a negative electrode current collector and includes a carbon material as a negative electrode active material and a binder until dry, and placing the layer under a hydrogen-containing atmosphere.

### TECHNICAL FIELD

One exemplary aspect relates to a method for producing a negative electrode for a lithium ion battery. Another exemplary aspect relates to a method for producing a lithium ion battery.

### BACKGROUND ART

With miniaturization of electronic devices, batteries having excellent performance are demanded, and lithium ion batteries are gaining attention as batteries having a high energy density. Then, as a negative electrode active material for lithium ion batteries, carbon materials such as graphite are used.

Carbon materials for negative electrode active materials can be obtained by thermally-treating a carbon raw material such as a graphitizable material, a non-graphitizable material, or a polymer material at a high temperature under an inert-gas atmosphere. It is known that such thermal treatment causes the surface state of carbon materials to be unstable. In order to improve the surface state of carbon materials, several suggestions have been made as shown in the following Patent Literatures.

Patent Literature 1 describes a method for producing a carbon material for negative electrodes, wherein a carbon raw material is thermally-treated at 650 to 1100° C. under an inert-gas atmosphere and additionally thermally-treated at 650 to 1100° C. under a reducing atmosphere. The literature mentions that, in this production method, thermal treatment of the carbon raw material thermally-treated under an inert-gas atmosphere under a reducing atmosphere enables removal of functional groups such as —OH and —COOH at the end of the carbon layer.

Patent Literature 2 describes a production method including a step of subjecting a graphitized material to first thermal treatment at 600° C. or more to thereby form an amorphous carbon material, and a second thermal treatment step of subjecting the amorphous carbon material to thermal treatment in hydrogen gas or in a mixed gas of hydrogen gas and an inert gas.

Patent Literature 3 mentions that treatment can be conducted in an atmosphere containing hydrogen gas at a temperature of 200° C. or more or by irradiation with hydrogen plasma generated by glow discharge etc., in order to reduce dangling bonds of carbon material (paragraph [0032]).

Patent Literature 4 describes a method for producing a carbon material comprising a step of surface-treating a low crystalline carbon material powder with compression shear force and a step of heating the surface-treated low crystalline carbon material powder to 2000° C. or more to thereby be graphitized. The Patent Literature mentions that dangling bonds are reduced after the surface treatment that gives compression and applies shear force (paragraph [0016]). As a method for reducing dangling bonds, for example, a method including heating the powder in an inert gas atmosphere at 2000° C. or more is described.

### CITATION LIST

### Patent Literature

### Patent Literature 1: JP8-180868A

### Patent Literature 2: JP9-22696A

### Patent Literature 3: JP9-245794A

### Patent Literature 4: JP2011-216231A

### SUMMARY OF INVENTION

### Technical Problem

It is an object of the present invention to provide a method for producing a negative electrode that enables a lithium ion battery having an excellent capacity retention rate to be provided. It is another object of the present invention to provide a method for producing a lithium ion battery having an excellent capacity retention rate.

### Solution to Problem

One exemplary aspect is

a method for producing a negative electrode for a lithium ion battery comprising heat-treating a negative electrode active material layer placed on a negative electrode current collector and including a carbon material as a negative electrode active material and a binder until dry, and placing the layer under a hydrogen-containing atmosphere.

One exemplary aspect is

a method for producing a lithium ion battery comprising an electrode assembly that includes a negative electrode containing a carbon material as a negative electrode active material, a positive electrode, and a separator, a package, and an electrolytic solution, wherein the method comprises heat-treating the electrode assembly placed in the package until dry, and placing the assembly under a hydrogen-containing atmosphere.

One exemplary aspect is

a method for producing a negative electrode for a lithium ion battery comprising placing a negative electrode slurry including a carbon material as a negative electrode active material, a binder, and a solvent on a negative electrode current collector, heat-treating the negative electrode slurry on the negative electrode current collector until dry, and placing the slurry under a hydrogen-containing atmosphere.

### Advantageous Effect of Invention

One exemplary aspect can provide a method for producing a negative electrode that enables a lithium ion battery having an excellent capacity retention rate to be provided. Another exemplary aspect can provide a method for producing a lithium ion battery having an excellent capacity retention rate.

### BRIEF DESCRIPTION OF DRAWINGS

FIG. 1 is a schematic cross-sectional view showing an exemplary configuration of a lithium ion battery in the present exemplary embodiment.

FIG. 2 is a graph showing the measurement results of the capacity retention rate in the present examples.

### DESCRIPTION OF EMBODIMENTS

As shown in Patent Literatures described above, consideration on surface treatment on producing a carbon material has been made. A carbon material can be obtained by heating a carbon raw material at a high temperature, for example, at 1000° C. or more. The methods described in the above Patent Literatures have been proposed in order to improve the surface state of the carbon material unstabilized by the heat treatment at this time.

However, the present inventors have found that drying performed after a negative electrode active material layer is formed also unstabilizes the surface of the carbon material. The present inventors have also found that this surface state can be stabilized by treatment with hydrogen, and as a result, a lithium ion battery having an excellent capacity retention rate can be provided, having completed the present invention. The mechanism to exert the effect of the present invention is assumed as follows. First, dangling bonds have been formed on the surface of the carbon material by the heat on drying, and a conventional method allows moisture or the like to adhere to these dangling bonds after drying. Then, in the present invention, dangling bonds formed by the heat on drying are terminated with hydrogen to enable to prevent moisture or the like from adhering thereto after drying. As a result, a negative electrode having excellent performance can be provided. Incidentally, the assumption of this mechanism does not limit the present invention.

Exemplary embodiments will be described below.

### First Exemplary Embodiment

A first exemplary embodiment relates to a method for producing a negative electrode for a lithium ion battery. Additionally, in the first exemplary embodiment, a negative electrode active material layer placed on a negative electrode current collector and including a carbon material as a negative electrode active material and a binder (negative electrode binding agent) is heat-treated until dry, and placed under a hydrogen-containing atmosphere. In the present exemplary embodiment, dangling bonds generated on the carbon material by the heat treatment can be terminated with hydrogen in the hydrogen-containing atmosphere. This can prevent the dangling bonds generated on the carbon material from reacting with moisture in the atmosphere, that is, can prevent the moisture from adhering to the carbon material. Incidentally, the assumption of this mechanism does not limit the present invention.

An exemplary aspect of the present exemplary embodiment comprises a drying step of drying a negative electrode active material layer, and a hydrogen treatment step of subjecting the dried negative electrode active material layer to hydrogen treatment. In other words, an exemplary aspect of the present exemplary embodiment comprises a drying step of drying a negative electrode active material layer by heat treatment, and a hydrogen treatment step of placing the dried negative electrode active material layer under a hydrogen-containing atmosphere.

Another exemplary aspect of the present exemplary embodiment comprises a dry hydrogen treatment step of subjecting a negative electrode active material layer to hydrogen treatment while drying. In other words, an exemplary aspect of the present exemplary embodiment comprises a dry hydrogen treatment step of drying a negative electrode active material layer by heat treatment in a state that the layer is placed under a hydrogen-containing atmosphere.

Exemplary embodiments will be described in detail below.

A negative electrode active material layer includes a carbon material as a negative electrode active material and a binder (negative electrode binding agent).

The negative electrode active material layer can be fabricated as follows. First, a negative electrode slurry including a carbon material as a negative electrode active material, a negative electrode binding agent (binder), and a solvent is placed on a negative electrode current collector. Then, the solvent is dried off to thereby form a negative electrode active material layer. After drying, the negative electrode active material layer may be pressed as required.

Examples of the method for applying the negative electrode slurry include a doctor blade method, a die coater method, and a dip coating method.

The carbon material as a negative electrode active material may intercalate and release lithium ions. The carbon material is not particularly limited, and, for example, graphite (artificial graphite and natural graphite), hard carbon (non-graphitizable carbon), soft carbon (graphitizable carbon), diamond-like carbon, carbon nanotubes, or composites thereof can be used. Among these, graphite or hard carbon is preferably used. One of the carbon materials may be used alone, or two or more of these can be used in combination.

The negative electrode active material may include an active material other than the carbon material. Examples of the active material other than the carbon material include metals capable of being alloyed with lithium and metal oxides capable of intercalating and releasing lithium ions. Examples of the metals capable of being alloyed with lithium include silicon, tin, or alloys thereof. Examples of the metal oxides capable of intercalating and releasing lithium ions include silicon oxide, aluminum oxide, tin oxide, indium oxide, zinc oxide, lithium oxide, or composites thereof. The content of the carbon material in the negative electrode active material is not particularly limited, and is, for example, 30% by mass or more, preferably 50% by mass or more, more preferably 70% by mass or more, further more preferably 90% by mass or more, and particularly preferably 100% by mass.

The negative electrode binding agent is not particularly limited. Examples thereof include polyvinylidene fluoride, vinylidene fluoride-hexafluoropropylene copolymers, vinylidene fluoride-tetrafluoroethylene copolymers, styrene-butadiene copolymerized rubbers, polytetrafluoroethylene, polypropylene, polyethylene, polyimides, polyamideimides, and polyacrylic acid. Among these, polyvinylidene fluoride or styrene-butadiene copolymerized rubbers are preferred due to their strong bindability. The amount of the negative electrode binding agent is preferably 0.5 to 25 parts by mass, more preferably 1 to 5 parts by mass based on 100 parts by mass of the negative electrode active material. One of the negative electrode binding agents may be used alone, or two or more of these can be used in combination.

The solvent used for the negative electrode slurry is not particularly limited, and examples thereof include nonaqueous solvents such as NMP (N-methylpyrrolidone). In addition, when an aqueous polymer is used as the negative electrode binding agent, an aqueous solvent can be used. Examples of the aqueous solvent, other than water, include alcohol-based solvents, amine-based solvents, carboxylic acid-based solvents, or ketone-based solvents.

The negative electrode slurry may contain other components as needed. Examples of other components include surfactants and defoaming materials. When the negative electrode slurry contains a surfactant, the dispersion stability of the negative electrode binding agent can be improved. In addition, when the negative electrode slurry contains a defoaming agent, foaming when a slurry containing a surfactant is applied can be suppressed.

The negative electrode active material layer may contain a conductive aid such as carbon from the viewpoint of improving its conductivity.

The negative electrode current collector is not particularly limited. Examples thereof include metals such as aluminum, nickel, stainless, chromium, copper or silver or alloys thereof. Examples of the shape of the negative electrode current collector include foil, a flat plate shape, and a mesh shape.

In the present exemplary embodiment, the negative electrode active material layer is heat-treated until dry and placed under a hydrogen-containing atmosphere. As described above, after the drying step of drying a negative electrode active material layer is conducted, a hydrogen treatment step of subjecting the dried negative electrode active material layer to hydrogen treatment may be conducted. Alternatively, a dry hydrogen treatment step of subjecting a negative electrode active material layer to hydrogen treatment while drying may be conducted.

First, an exemplary aspect in which, after the drying step of drying a negative electrode active material layer is conducted, a hydrogen treatment step of subjecting the dried negative electrode active material layer to hydrogen treatment is conducted will be described. In other words, an exemplary embodiment comprising a drying step of drying a negative electrode active material layer by heat treatment, and a hydrogen treatment step of placing the dried negative electrode active material layer under a hydrogen-containing atmosphere will be described.

<Drying Step>

In the drying step, a negative electrode active material layer formed on a negative electrode current collector is heat-treated until dry. The drying step can remove moisture and the like that have adhered to the negative electrode active material layer and the negative electrode current collector.

The drying step may be conducted in the atmosphere and is preferably conducted under an inert gas atmosphere. Examples of the inert gas include nitrogen, argon, or helium. The drying step can be conducted also under reduced pressure.

The temperature of the heat treatment in the drying step is not particularly limited as long as moisture, the solvent or the like is removed at the temperature. The temperature of the heat treatment is preferably 80° C. or more, more preferably 90° C. or more, further more preferably 100° C. or more from the viewpoint of removal of moisture, the solvent or the like. Additionally, the temperature of the heat treatment is preferably 200° C. or less, more preferably 190° C. or less, further more preferably 180° C. or less from the viewpoint of the stability of materials such as the binder. In particular, when the temperature of the heat treatment is 80° C. or more, it is assumed that many dangling bonds are generated on the carbon material surface, from which the effect of the invention of the present application can be more significantly confirmed.

A drying apparatus used for the drying step is not particularly limited. The negative electrode active material layer can be placed in the drying furnace in the drying apparatus until dry. The negative electrode active material layer may be dried while transferred in the drying furnace. Additionally, in the present exemplary embodiment, drying is preferably conducted under an inert gas atmosphere. Thus, the negative electrode active material layer is preferably allowed to stand still in the drying furnace of the drying apparatus and dried in the drying furnace with an inert gas circulated. On drying, a roll-shape negative electrode active material layer may be placed in the drying furnace or flat-shape negative electrode active material layers may be placed alongside in the drying furnace. The drying apparatus may comprise an inert gas supply port for supplying an inert gas to the drying furnace where the negative electrode active material is to be placed.

The drying apparatus comprises a temperature controlling mechanism capable of controlling the temperature. For example, the temperature controlling mechanism includes a heating part such as a heater. The temperature controlling mechanism can also include a cooling part as required.

Drying time is not particularly limited, and appropriately selected in consideration of the degree of removal of moisture and the like. For example, when the negative electrode is in a flat shape, the heating time is from 3 to 60 minutes. When the negative electrode is in a roll shape, the heating time is from 1 to 6 hours.

<Hydrogen Treatment Step>

In a hydrogen treatment step, the negative electrode active material layer dried in the drying step is placed under a hydrogen-containing atmosphere. By this hydrogen treatment step, dangling bonds generated by the heat treatment in the drying step are terminated.

The hydrogen-containing atmosphere contains hydrogen gas at a concentration suitable for hydrogen treatment. The concentration of hydrogen gas may be a concentration at which the effect of the invention of the present application can be exerted. The volume proportion of hydrogen gas in the hydrogen-containing atmosphere is, for example, 0.1% or more, preferably 0.3% or more, further more preferably 0.5% or more. The volume proportion of hydrogen gas in the hydrogen-containing atmosphere is, for example, 5% or less, preferably 4% or less.

Additionally, the hydrogen-containing atmosphere is preferably a mixed gas containing hydrogen gas and an inert gas (hydrogen-containing inert gas atmosphere). In this case, the volume proportion of hydrogen gas is preferably 0.3% or more, more preferably 0.5% or more, further more preferably 1% or more. Additionally, the volume proportion of hydrogen gas is preferably 5% or less, more preferably 4% or less. The volume proportion of the inert gas is preferably 90% or more, more preferably 95% or more, further more preferably 96% or more. Additionally, the volume proportion of the inert gas is preferably 99.7% or less, more preferably 99.5% or less, further more preferably 99% or less.

The treatment temperature in the hydrogen treatment is preferably 20° C. or more, more preferably 25° C. or more, further more preferably 40° C. or more, and particularly preferably 60° C. or more. When the treatment temperature is 20° C. or more, the dangling bonds generated on the carbon material surface in the drying step can be effectively terminated with hydrogen. Additionally, the treatment temperature in the hydrogen treatment step is preferably 200° C. or less, more preferably 190° C. or less, further more preferably 180° C. or less from the viewpoint of the stability of negative electrode materials such as the binder.

In the present exemplary embodiment, dangling bonds are generated on the carbon material surface by the heat treatment of the drying step. These generated dangling bonds are terminated with hydrogen to thereby prevent moisture or the like from adhering to the carbon material surface. As a result, it is assumed that a negative electrode having excellent performance can be obtained. Thus, transfer from the drying step to the hydrogen treatment step is preferably conducted as fast as possible, and the drying step and the hydrogen treatment step are preferably conducted sequentially in the same drying furnace. Specifically, feeding hydrogen gas to the drying furnace of the drying apparatus used for the drying step after the drying step can provide a hydrogen-containing atmosphere for the hydrogen treatment step. An exemplary aspect is a method in which the drying step and the hydrogen treatment step are conducted in the same drying furnace, the drying step is conducted under an inert gas atmosphere, and then, hydrogen gas is fed to the inert gas atmosphere to thereby provide a hydrogen-containing inert gas atmosphere containing an inert gas and hydrogen gas. The drying apparatus may comprise a hydrogen gas supply port for supplying a hydrogen gas, in addition to the inert gas supply port for supplying an inert gas, in the drying furnace in which a negative electrode active material is to be placed.

Additionally, the hydrogen-containing atmosphere may be circulated in the apparatus.

Hydrogen treatment time is not particularly limited. For example, when the negative electrode active material layer is in a flat shape, the treatment time is from 3 to 30 minutes. When the negative electrode active material layer is taken up in a roll shape, the treatment time is from 1 to 3 hours.

After the hydrogen treatment step, a step of cooling the negative electrode active material layer may be included. The negative electrode active material layer is preferably taken out of the apparatus after the temperature of the layer is reduced. In other words, after the hydrogen treatment step is conducted, the negative electrode active material layer is preferably taken out after the temperature of the layer is reduced in the hydrogen-containing atmosphere to room temperature, for example.

Subsequently, an exemplary aspect in which the negative electrode active material layer is hydrogen-treated while being dried will be described. In other words, an exemplary aspect comprising a dry hydrogen treatment step of drying the negative electrode active material layer by heat treatment in a state that the layer is placed under a hydrogen-containing atmosphere will be described.

<Dry Hydrogen Treatment Step>

In a dry hydrogen treatment step, the negative electrode active material layer is heat-treated under a hydrogen-containing atmosphere until dry. In the present exemplary embodiment, the negative electrode active material layer can be dried while dangling bonds to be generated by heat treatment on the carbon material surface are terminated with hydrogen. It is assumed that this can prevent the dangling bonds generated on the carbon material in the drying step by heat treatment from reacting with moisture in the atmosphere, that is, can prevent moisture from adhering to the carbon material.

The hydrogen-containing atmosphere is as described in the description of the hydrogen treatment step aforementioned. The volume proportion of hydrogen gas in the hydrogen-containing atmosphere is 0.1% or more, for example. Additionally, the hydrogen-containing atmosphere is preferably a mixed gas containing hydrogen gas and an inert gas (hydrogen-containing inert gas atmosphere).

The temperature of the heat treatment in the dry hydrogen treatment step is not particularly limited as long as moisture, the solvent or the like in the negative electrode active material layer is removed at the temperature. The temperature of the heat treatment is preferably 80° C. or more, more preferably 90° C. or more, further more preferably 100° C. or more from the viewpoint of removal of moisture, the solvent or the like. Additionally, the temperature of the heat treatment is preferably 200° C. or less, more preferably 190° C. or less, further more preferably 180° C. or less from the viewpoint of the stability of materials such as the binder. In particular, when the temperature of the heat treatment is 80° C. or more, it is assumed that many dangling bonds are generated on the carbon material surface, from which the effect of the invention of the present application can be more significantly confirmed.

As the drying apparatus used in the dry hydrogen treatment step, a drying apparatus described above can be used.

Dry hydrogen treatment time is not particularly limited, and appropriately selected in consideration of the degree of removal of moisture or the solvent or the like. For example, when the negative electrode active material layer is in a flat shape, the treatment time is from 3 to 60 minutes. When the negative electrode active material layer is taken up in a roll shape, the treatment time is from 1 to 6 hours.

After the dry hydrogen treatment step, a step of cooling the negative electrode active material layer may be included. The negative electrode active material layer is preferably taken out of the drying furnace of the apparatus after its temperature is reduced. In other words, after the dry hydrogen treatment step is conducted, the negative electrode active material layer is preferably taken out after the temperature of the layer is reduced in the hydrogen-containing atmosphere to room temperature, for example.

### Second Exemplary Embodiment

The second exemplary embodiment relates to a method for producing a lithium ion battery comprising an electrode assembly including a negative electrode that contains a carbon material as a negative electrode active material, a positive electrode, and a separator, a package, and an electrolytic solution. Additionally, in the present exemplary embodiment, the electrode assembly placed in the package is heat-treated until dry, and placed under a hydrogen-containing atmosphere. In the present exemplary embodiment, dangling bonds generated on the carbon material by the heat treatment for drying can be terminated with hydrogen in the hydrogen-containing atmosphere. This can prevent the dangling bonds generated on the carbon material from reacting with moisture in the atmosphere, that is, can prevent moisture from adhering to the carbon material. Incidentally, the assumption of this mechanism does not limit the present invention.

One exemplary aspect of the present exemplary embodiment comprises a drying step of heat-treating an electrode assembly placed in a package until dry, a hydrogen treatment step of placing the electrode assembly placed in the package under a hydrogen-containing atmosphere, and a solution injection step of injecting an electrolytic solution in the package, in this order. After the electrolytic solution is injected in the package, the package is sealed. In this exemplary aspect, the drying step and the hydrogen treatment step are conducted after the electrode assembly is placed in the package and before the electrolytic solution is injected in the package. Moisture and the like contained in the negative electrode, the positive electrode, the separator and the like are removed by the drying step. Thereafter, dangling bonds generated in the drying step can be terminated with hydrogen by conducting the hydrogen treatment step. As a result, a battery having an excellent capacity retention rate can be obtained, compared with lithium ion batteries fabricated without being subjected to the hydrogen treatment step.

Additionally, one exemplary aspect of the present exemplary embodiment comprises a dry hydrogen treatment step of drying the electrode assembly placed in the package by heat treatment in a state that the assembly is placed under a hydrogen-containing atmosphere, and a solution injection step of injecting the electrolytic solution in the package in this order. In this exemplary aspect, the dry hydrogen treatment step is conducted after the electrode assembly is placed in the package and before the electrolytic solution is injected in the package. This exemplary aspect is an exemplary aspect in which the heat treatment for drying and the hydrogen treatment are conducted simultaneously, enabling the electrode assembly to be dried while dangling bonds generated by the heat treatment are terminated with hydrogen.

In the present exemplary embodiment, drying is conducted in the step immediately before the electrolytic solution is injected and the package is sealed. Thus, moisture remaining inside can be minimized. Accordingly, a lithium ion battery having more excellent performance can be provided.

The description in the first exemplary embodiment can be applicable to the drying step, the hydrogen treatment step, or the dry hydrogen treatment step in the present exemplary embodiment, and thus, the description of such steps is omitted. The components of the battery will be described below.

<Negative Electrode>

The negative electrode includes a negative electrode active material layer containing a carbon material as a negative electrode active material. The negative electrode active material layer is formed on the negative electrode current collector. The negative electrode can be fabricated by placing a negative electrode slurry including a carbon material as a negative electrode active material, a negative electrode binding agent (binder), and a solvent on a negative electrode current collector followed by drying the slurry to remove the solvent. The negative electrode may be fabricated by pressing the negative electrode active material layer after drying.

<Positive Electrode>

The positive electrode comprises a positive electrode active material layer including a positive electrode active material and a positive electrode binder. The positive electrode active material can be bound on a positive electrode current collector with a positive electrode binding agent.

The positive electrode active material is not particularly limited. Examples thereof include lithium complex oxides and iron lithium phosphate. In addition, those in which at least parts of the transition metals of these lithium complex oxides are replaced by other elements may be used. In addition, lithium complex oxides with a plateau at a metal lithium counter electrode potential of 4.2 V or more can also be used. Examples of the lithium complex oxides include spinel type lithium manganese complex oxides, olivine type lithium-containing complex oxides, and inverse spinel type lithium-containing complex oxides.

Examples of the lithium complex oxides include lithium manganate having a layered structure or lithium manganate having a spinel structure such as LiMnO₂ or LiₓMn₂O₄ (0<x<2), or those in which part of the Mn of these lithium manganates is replaced by at least one element selected from the group consisting of Li, Mg, Al, Co, B, Ti, and Zn; lithium cobaltate such as LiCoO₂, or those in which part of the Co of lithium cobaltate is replaced by at least one element selected from the group consisting of Ni, Al, Mn, Mg, Zr, Ti, and Zn; lithium nickelate such as LiNiO₂, or those in which part of the Ni of lithium nickelate is replaced by at least one element selected from the group consisting of Co, Al, Mn, Mg, Zr, Ti, and Zn; lithium transition metal oxides in which particular transition metals do not exceed half, such as LiNi_{1/3}Co_{1/3}Mn_{1/3}O₂, or those in which parts of the transition metals of the lithium transition metal oxides are replaced by at least one element selected from the group consisting of Co, Al, Mn, Mg, and Zr; and these lithium transition metal oxides in which Li is more excessive than in stoichiometric compositions. Particularly, as the lithium complex oxides, Li_{α}Ni_{β}Co_{γ}Al_{δ}O₂ (1≦α≦1.2, β+γ+δ=1, β≧0.7, and γ≦0.2) or Li_{α}Ni_{β}Co_{γ}Mn_{δ}O₂ (1≦α≦1.2, β+γ+δ=1, β≧0.4, and γ≦0.4), or those in which parts of the transition metals of these complex oxides are replaced by at least one element selected from the group consisting of Al, Mg, and Zr are preferred. One of these lithium complex oxides may be used alone, or two or more of these lithium complex oxides may be used in combination.

In addition, as the positive electrode active material, active materials that operate at potentials of 4.5 V or more versus lithium (hereinafter also referred to as 5 V class active materials) can be used from the viewpoint that high voltage is obtained.

The positive electrode can be fabricated, for example, as follows. First, a positive electrode slurry comprising a positive electrode active material, a positive electrode binding agent, and a solvent (and further a conductive auxiliary material as needed) is prepared. This positive electrode slurry is applied on a positive electrode current collector and dried, and pressure is applied as needed, to form a positive electrode active material layer on the positive electrode current collector to fabricate a positive electrode.

The positive electrode binding agent is not particularly limited, and, for example, the same ones as the negative electrode binding agent can be used. From the viewpoint of versatility and low cost, polyvinylidene fluoride is preferred. The content of the positive electrode binding agent is preferably in the range of 1 to 25 parts by mass, more preferably in the range of 2 to 20 parts by mass, and further preferably in the range of 2 to 10 parts by mass based on 100 parts by mass of the positive electrode active material from the viewpoint of binding force and energy density in a trade-off relationship. Examples of binding agents other than polyvinylidene fluoride (PVdF) include vinylidene fluoride-hex afluoropropylene copolymers, vinylidene fluoride-tetrafluoroethylene copolymers, styrene-butadiene copolymerized rubbers, polytetrafluoroethylene, polypropylene, polyethylene, polyimides, or polyamideimides. As the solvent, for example, N-methyl-2-pyrrolidone (NMP) can be used.

The positive electrode current collector is not particularly limited. Examples thereof include aluminum, titanium, tantalum, nickel, silver, or alloys thereof. Examples of the shape of the positive electrode current collector include foil, a flat plate shape, and a mesh shape. As the positive electrode current collector, aluminum foil can be preferably used.

In the fabrication of the positive electrode, a conductive auxiliary material may be added for the purpose of decreasing impedance. Examples of the conductive auxiliary material include carbonaceous fine particles such as graphite, carbon black, and acetylene black.

<Separator>

The separator is not particularly limited, and, for example, porous films and nonwoven fabrics of polypropylene, polyethylene, and the like can be used. In addition, as the separator, ceramic-coated separators in which coatings comprising ceramics are formed on polymer base materials used as separators can also be used. In addition, as the separator, their stacks can also be used.

<Package>

The package is not particularly limited, and, for example, laminate films can be used. For example, in the case of a stacking laminate type secondary battery, laminate films of aluminum, silica-coated polypropylene, polyethylene, and the like can be used.

<Electrolytic Solution>

The electrolytic solution is not particularly limited, and, for example, includes a supporting salt and a nonaqueous solvent. The electrolytic solution may include a gelling agent.

The supporting salt is not particularly limited. Examples thereof include lithium salts such as LiPF₆, LiAsF₆, LiAlCl₄, LiClO₄, LiBF₄, LiSbF₆, LiCF₃SO₃, LiC₄F₉SO₃, Li(CF₃SO₂)₂, and LiN(CF₃SO₂)₂. One of the supporting salts may be used alone, or two or more of these can be used in combination.

The concentration of the supporting salt in the electrolytic solution is preferably 0.5 to 1.5 mol/l. By setting the concentration of the supporting salt in this range, the density, viscosity, electrical conductivity, and the like are easily adjusted in suitable ranges.

The nonaqueous solvent is not particularly limited. Examples thereof include carbonates such as cyclic carbonates and chain carbonates, aliphatic carboxylates, γ-lactones, cyclic ethers, chain ethers, and fluorine derivatives thereof. One of the nonaqueous solvents may be used alone, or two or more of these can be used in combination.

Examples of the cyclic carbonates include propylene carbonate (PC), ethylene carbonate (EC), butylene carbonate (BC), and vinylene carbonate (VC).

Examples of the chain carbonates include dimethyl carbonate (DMC), diethyl carbonate (DEC), ethyl methyl carbonate (EMC), and dipropyl carbonate (DPC).

Examples of the aliphatic carboxylates include methyl formate, methyl acetate, and ethyl propionate.

Examples of the γ-lactones include γ-butyrolactone.

Examples of the cyclic ethers include tetrahydrofuran and 2-methyltetrahydrofuran.

Examples of the chain ethers include 1,2-diethoxyethane (DEE) and ethoxymethoxyethane (EME).

In addition, examples of the nonaqueous solvent include dimethyl sulfoxide, 1,3-dioxolane, formamide, acetamide, dimethylformamide, acetonitrile, propylnitrile, nitromethane, ethyl monoglyme, phosphate triesters, trimethoxymethane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, N-methylpyrrolidone, fluorinated carboxylates, methyl-2,2,2-trifluoroethyl carbonate, methyl-2,2,3,3,3-pentafluoropropyl carbonate, trifluoromethylethylene carbonate, monofluoromethylethylene carbonate, difluoromethylethylene carbonate, 4,5-difluoro-1,3-dioxolan-2-one, and monofluoroethylene carbonate. One of these can be used alone, or two or more of these can be used in combination.

The nonaqueous solvent preferably comprises a carbonate. The carbonates include cyclic carbonates or chain carbonates. Advantages of the carbonates are that the relative dielectric constant is large, and therefore the ion dissociation properties of the electrolytic solution improve, and further the viscosity of the electrolytic solution decreases, and therefore the ion mobility improves. The content of the carbonate in the electrolytic solution is, for example, 30% by mass or more, preferably 50% by mass or more, and more preferably 70% by mass or more.

<Battery Configuration>

The battery according the present exemplary embodiment has a configuration in which an electrode assembly including a positive electrode and a negative electrode disposed opposed to each other via a separator and an electrolytic solution are included in a package.

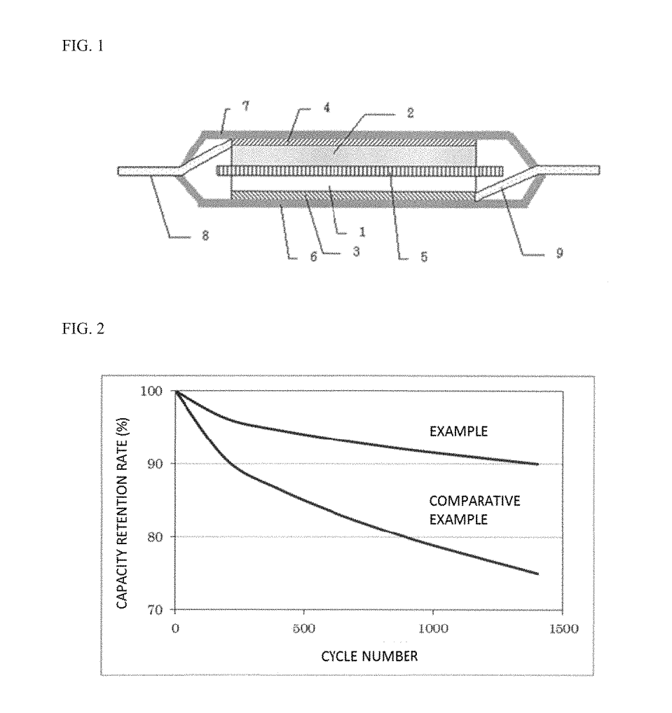

A stacking laminate type lithium ion secondary battery will be described below as an example. FIG. 1 is a schematic configuration diagram showing one example of the basic configuration of the secondary battery according to the present exemplary embodiment. In the positive electrode, a positive electrode active material layer 1 is formed on a positive electrode current collector 3. In the negative electrode, a negative electrode active material layer 2 is formed on a negative electrode current collector 4. These positive electrode and negative electrode are disposed opposed to each other via a separator 5 to configure an electrode assembly. The separator 5 is stacked and disposed generally parallel to the positive electrode active material layer 1 and the negative electrode active material layer 2. The electrode pair of the positive electrode and the negative electrode and an electrolytic solution are included in packages 6 and 7. A positive electrode tab 9 connected to the positive electrode, and a negative electrode tab 8 connected to the negative electrode are provided so as to be exposed from the packages. The shape of the secondary battery according to the present exemplary embodiment is not particularly limited. Examples thereof include a laminate packaging type, a cylindrical type, a prismatic type, a coin type, and a button type.

An exemplary step for producing the battery will be described below.

A positive electrode having a positive electrode terminal and a negative electrode having a negative electrode terminal are stacked alternately via a sheet separator to form an electrode assembly. In this case, the positive electrode and the negative electrode can be stacked such that the positive electrode terminal and the negative electrode terminal are oriented in the same direction. In other words, the positive electrode terminal and the negative electrode terminal can be positioned on the same side of the electrode assembly. However, in order to prevent a short circuit caused by contact between the positive electrode terminal and the negative electrode terminal, the positive electrode terminal and the negative electrode terminal are placed so as not to be overlapped. Each positive electrode terminal is connected to the positive electrode lead, and each negative electrode terminal is connected to the negative electrode lead.

Then, the electrode assembly is placed in a package composed of a flexible laminate film, which is formed by covering the both sides of metal foil such as aluminum foil with a resin layer. The positive electrode lead and the negative electrode lead are drawn out from the package.

Then, the package including the electrode assembly inside is placed in the drying furnace of the drying apparatus, and a drying step is conducted. Subsequently, hydrogen gas is fed to drying furnace, and hydrogen treatment is conducted.

Then, after the temperature is decreased to room temperature, the package including the electrode assembly inside is taken out of the drying furnace, and an electrolytic solution is injected into the package. Thereafter, the pressure inside is reduced as required, and the package is sealed. Sealing can be conducted by heat welding, for example.

### Third Exemplary Embodiment

A third exemplary embodiment relates to a method for producing a negative electrode for a lithium ion battery. Additionally, in the third exemplary embodiment of the present invention, a negative electrode slurry including a carbon material as a negative electrode active material, a binder, and a solvent is placed on a negative electrode current collector, and the negative electrode slurry on the negative electrode current collector is heat-treated until dry and placed under a hydrogen-containing atmosphere. In the present exemplary embodiment, dangling bonds generated on the carbon material by the heat treatment for removing the solvent can be terminated with hydrogen in the hydrogen-containing atmosphere. This can prevent the dangling bonds generated on the carbon material from reacting with moisture in the atmosphere, that is, can prevent moisture from adhering to the carbon material.

Incidentally, the assumption of this mechanism does not limit the present invention.

In the present exemplary embodiment, first, a negative electrode slurry including a carbon material as a negative electrode active material, a binder, and a solvent is placed on a negative electrode current collector. Then, it is necessary to conduct heat treatment in order to remove the solvent in the slurry layer composed of the negative electrode slurry. In the present exemplary embodiment, this drying is conducted in the drying step described above or the dry hydrogen treatment step described above. Incidentally, the carbon material, the binder, the solvent, the negative electrode slurry, the negative electrode current collector and the like are as described in the first exemplary embodiment.

One exemplary aspect of the present exemplary embodiment comprises a drying step of drying the negative electrode slurry to remove the solvent, and a hydrogen treatment step of subjecting the negative electrode active material layer to hydrogen treatment. In other words, the exemplary aspect of the present exemplary embodiment comprises a drying step of drying the negative electrode slurry on the negative electrode current collector by heat treatment to remove the solvent to thereby form a negative electrode active material layer, and a hydrogen treatment step of placing the negative electrode active material layer under a hydrogen-containing atmosphere.

Another exemplary aspect of the present exemplary embodiment comprises a dry hydrogen treatment step of subjecting the negative electrode active material layer to hydrogen treatment while drying. In other words, the exemplary aspect of the present exemplary embodiment comprises a dry hydrogen treatment of drying the negative electrode slurry on the negative electrode current collector by heat treatment in a state that the slurry is placed under a hydrogen-containing atmosphere to remove the solvent to thereby form a negative electrode active material layer.

The description in the first exemplary embodiment can be applicable to the drying step, the hydrogen treatment step, or the dry hydrogen treatment step in the present exemplary embodiment, and thus, the description of such steps is omitted.

### Examples

Examples of the present invention will be described below. Incidentally, the present invention is not limited to the following Examples.

### Examples

<Negative Electrode>

As a negative electrode active material, hard carbon was used. This negative electrode active material, polyvinylidene fluoride as a negative electrode binding agent, and acetylene black as a conductive auxiliary material were measured at a mass ratio of 75:20:5. Then, these were mixed with N-methylpyrrolidone to prepare a negative electrode slurry. The negative electrode slurry was applied to copper foil having a thickness of 10 μm (negative electrode current collector) followed by drying to remove the solvent and further pressing to form a negative electrode active material layer.

The negative electrode active material layer obtained was placed in the drying furnace of a drying apparatus, and nitrogen was fed to the drying furnace. Thereafter, heat treatment under a nitrogen atmosphere at 120° C. was conducted for 15 minutes to dry the negative electrode active material layer.

Following the drying step, hydrogen was fed to the drying furnace. In this case, hydrogen was fed such that the hydrogen concentration (volume proportion) reached 4%. Then, heat treatment under a hydrogen-containing atmosphere at 120° C. was conducted for 15 minutes to provide hydrogen treatment to thereby fabricate a negative electrode. Incidentally, after the temperature of the negative electrode obtained was decreased to room temperature, the negative electrode was taken out of the drying furnace.

<Positive Electrode>

As a positive electrode active material, LiMn₂O₄ was used. This positive electrode active material, carbon black as a conductive auxiliary material, and polyvinylidene fluoride as a positive electrode binding agent were measured at a mass ratio of 90:5:5. Then, these were mixed with N-methylpyrrolidone to prepare a positive electrode slurry. The positive electrode slurry was applied to aluminum foil having a thickness of 20 μm followed by drying and further pressing to fabricate a positive electrode.

<Electrode Assembly>

The obtained positive electrode and negative electrode were stacked via a polypropylene porous film as a separator. Ends of the positive electrode current collector not covered with the positive electrode active material and of the negative electrode current collector not covered with the negative electrode active material were each welded. Further, a positive electrode terminal made of aluminum and a negative electrode terminal made of nickel were welded to the welded parts respectively to obtain an electrode assembly having a planar stacked structure.

<Electrolytic Solution>

As a nonaqueous solvent, a mixed solvent of EC and DEC (volume proportion: EC/DEC=30/70) was used. Then, LiPF₆ as a supporting salt was added to the mixed solvent so that the concentration in the electrolytic solution reached 1 M, thereby preparing the electrolytic solution.

<Secondary Battery>

The electrode assembly was housed in an aluminum laminate film as a package, and the electrolytic solution was injected into the inside of the package. Then, while the pressure was reduced to 0.1 atmospheres, the package was sealed to fabricate a lithium ion battery (secondary battery).

<Evaluation>

(Capacity Retention Rate)

Then, the fabricated lithium ion battery was subjected to a test of repeating charge and discharge in a voltage range of 2.5 V to 4.2 V in a thermostat kept at 45° C. and evaluated for the capacity retention rate (%). In the charge, the battery was charged at 1 C to 4.2 V, and then subjected to constant voltage charge for 2.5 hours in total. In the discharge, the battery was subjected to constant current discharge at 1 C to 2.5 V.

The measurement results of capacity retention rate in the present examples are shown in the graph of FIG. 2.

### Comparative Example

A lithium ion battery was fabricated and evaluated as in Example except that the hydrogen treatment step was not conducted. The measurement results of capacity retention rate in the present comparative example are shown in the graph of FIG. 2.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

### INDUSTRIAL APPLICABILITY

The lithium ion battery according to the exemplary embodiment can be applied, for example, to driving equipment such as electric vehicles, plug-in hybrid vehicles, electric motorcycles, and electrically assisted bicycles, tools such as electric tools, electronic equipment such as portable terminals and notebook computers, and storage batteries such as home electricity storage systems and solar power generation systems.

The present application claims the right of priority based on Japanese Patent Application No. 2014-159627 filed on Aug. 5, 2014, the entire disclosure of which is incorporated herein.

### REFERENCE SIGNS LIST

1 positive electrode active material layer
2 negative electrode active material layer
3 positive electrode current collector
4 negative electrode current collector
5 Separator
6 laminate package
7 laminate package
8 negative electrode tab
9 positive electrode tab

1. A method for producing a negative electrode for a lithium ion battery comprising
heat-treating a negative electrode active material layer that is placed on a negative electrode current collector and includes a carbon material as a negative electrode active material and a binder until dry, and
placing the layer under a hydrogen-containing atmosphere.

2. The method for producing a negative electrode for a lithium ion battery according to claim 1, comprising
a drying step of drying the negative electrode active material layer by the heat treatment, and
a hydrogen treatment step of placing the dried negative electrode active material layer under a hydrogen-containing atmosphere.

3. The method for producing a negative electrode for a lithium ion battery according to claim 2, wherein the drying step is conducted under an inert gas atmosphere.

4. The method for producing a negative electrode for a lithium ion battery according to claim 2, wherein the hydrogen-containing atmosphere is a mixed gas comprising hydrogen gas and an inert gas.

5. The method for producing a negative electrode for a lithium ion battery according to claim 2, wherein
the temperature of the heat treatment is 80° C. or more and 200° C. or less, and
the treatment temperature in the hydrogen treatment step is 200° C. or less.

6. The method for producing a negative electrode for a lithium ion battery according to claim 2, wherein the drying step and the hydrogen treatment step are conducted sequentially in the same drying furnace.

7. The method for producing a negative electrode for a lithium ion battery according to claim 2, wherein
the drying step is conducted under an inert gas atmosphere,
the hydrogen-containing atmosphere is a mixed gas comprising hydrogen gas and an inert gas, and
the drying step and the hydrogen treatment step are conducted sequentially in the same drying furnace.

8. The method for producing a negative electrode for a lithium ion battery according to claim 1, comprising a dry hydrogen treatment step of drying the negative electrode active material layer by the heat treatment in a state that the layer is placed under a hydrogen-containing atmosphere.

9. The method for producing a negative electrode for a lithium ion battery according to claim 8, wherein the hydrogen-containing atmosphere is a mixed gas comprising hydrogen gas and an inert gas.

10. The method for producing a negative electrode for a lithium ion battery according to claim 8, wherein the temperature of the heat treatment is 80° C. or more and 200° C. or less.

11. A method for producing a lithium ion battery comprising an electrode assembly including a negative electrode that contains a carbon material as a negative electrode active material, a positive electrode, and a separator, a package, and an electrolytic solution,
wherein the electrode assembly placed in the package is heat-treated until dry and placed under a hydrogen-containing atmosphere.

12. The method for producing a lithium ion battery according to claim 11, comprising
a drying step of drying the electrode assembly placed in the package by the heat treatment,
a hydrogen treatment step of placing the dried electrode assembly placed in the package under a hydrogen-containing atmosphere, and
a solution injection step of injecting the electrolytic solution in the package in this order.

13. The method for producing a lithium ion battery according to claim 12, wherein the drying step is conducted under an inert gas atmosphere.

14. The method for producing a lithium ion battery according to claim 12, wherein the hydrogen-containing atmosphere is a mixed gas comprising hydrogen gas and an inert gas.

15. The method for producing a lithium ion battery according to claim 12, wherein
the temperature of the heat treatment is 80° C. or more and 200° C. or less, and
the treatment temperature in the hydrogen treatment step is 200° C. or less.

16. The method for producing a lithium ion battery according to claim 12, wherein the drying step and the hydrogen treatment step are conducted sequentially in the same drying furnace.

17. The method for producing a lithium ion battery according to claim 12, wherein
the drying step is conducted under an inert gas atmosphere,
the hydrogen-containing atmosphere is a mixed gas comprising hydrogen gas and an inert gas, and
the drying step and the hydrogen treatment step are conducted sequentially in the same drying furnace.

18. The method for producing a lithium ion battery according to claim 11, comprising
a dry hydrogen treatment step of drying the electrode assembly placed in the package by the heat treatment in a state that the assembly is placed under a hydrogen-containing atmosphere, and
a solution injection step of injecting the electrolytic solution in the package in this order.

19. The method for producing a lithium ion battery according to claim 18, wherein the temperature of the heat treatment is 80° C. or more and 200° C. or less.

20. The method for producing a lithium ion battery according to claim 18, wherein the hydrogen-containing atmosphere is a mixed gas comprising hydrogen gas and an inert gas.

21. A method for producing a negative electrode for a lithium ion battery comprising
placing a negative electrode slurry including a carbon material as a negative electrode active material, a binder, and a solvent on a negative electrode current collector,
heat-treating the negative electrode slurry on the negative electrode current collector until dry, and
placing the slurry under a hydrogen-containing atmosphere.

22. The method for producing a negative electrode for a lithium ion battery according to claim 21, comprising
a drying step of drying the negative electrode slurry on the negative electrode current collector by the heat treatment to remove the solvent to thereby form a negative electrode active material layer, and
a hydrogen treatment step of placing the negative electrode active material layer under a hydrogen-containing atmosphere.

23. The method for producing a negative electrode for a lithium ion battery according to claim 22, wherein the drying step is conducted under an inert gas atmosphere.

24. The method for producing a negative electrode for a lithium ion battery according to claim 22, wherein the hydrogen-containing atmosphere is a mixed gas comprising hydrogen gas and an inert gas.

25. The method for producing a negative electrode for a lithium ion battery according to claim 22, wherein
the temperature of the heat treatment is 80° C. or more and 200° C. or less, and
the treatment temperature in the hydrogen treatment step is 200° C. or less.

26. The method for producing a negative electrode for a lithium ion battery according to claim 22, wherein the drying step and the hydrogen treatment step are conducted sequentially in the same drying furnace.

27. The method for producing a negative electrode for a lithium ion battery according to claim 22, wherein
the drying step is conducted under an inert gas atmosphere,
the hydrogen-containing atmosphere is a mixed gas comprising hydrogen gas and an inert gas, and
the drying step and the hydrogen treatment step are conducted sequentially in the same drying furnace.

28. The method for producing a negative electrode for a lithium ion battery according to claim 21, comprising a dry hydrogen treatment step of drying the negative electrode slurry on the negative electrode current collector by the heat treatment in a state that the slurry is placed under a hydrogen-containing atmosphere to remove the solvent to thereby form a negative electrode active material layer.

29. The method for producing a negative electrode for a lithium ion battery according to claim 28, wherein the temperature of the heat treatment is 80° C. or more and 200° C. or less.

30. The method for producing a negative electrode for a lithium ion battery according to claim 28, wherein the hydrogen-containing atmosphere is a mixed gas comprising hydrogen gas and an inert gas.
